(19) United States
(12) Patent Application Publication
(10) Pub. No.: US 2026/0142581 A1
(43) Pub. Date: May 21, 2026

(54) Converter And Control Method Therefor

(71) Applicant: Siemens Aktiengesellschaft, München (DE)

(72) Inventors: Qing Li Huang, Nanjing (CN); Peng Cheng Li, Shenzhen (CN); Xiao Long Chen, Nanjing (CN); Yan Hua Lu, Nanjing (CN); Yu Xu, Nanjing (CN)

(73) Assignee: Siemens Aktiengesellschaft, München (DE)

(21) Appl. No.: 19/121,363

(22) PCT Filed: Oct. 18, 2022
(86) PCT No.: PCT/CN2022/125910

§ 371 Date: Apr. 15, 2025

(51) Int. Cl. H02M 5/42; H02M 1/32

(52) U.S. Cl. CPC H02M 5/42; H02M 1/32

(57) ABSTRACT

Various embodiments of the teachings herein include a converter comprising: a Y capacitor with a first terminal and a second terminal; a switch with a third terminal and a fourth terminal; and a control unit to determine type information of a power supply system of the converter and control a state of the switch based on the type information. The first terminal is connected to a DC bus of the converter or the power supply system of the converter. The third terminal is connected to the second terminal. The fourth terminal is connected to ground.

### CROSS-REFERENCE TO RELATED APPLICATIONS

This application is a U.S. National Stage Application of International Application No. PCT/CN2022/125910 filed Oct. 18, 2022, which designates the United States of America, the contents of which are hereby incorporated by reference in their entirety.

### TECHNICAL FIELD

The present disclosure relates to electrical technology. Various embodiments of the teachings herein include converters and control methods therefor.

### BACKGROUND

A power electronic converter is an electrical device that changes the voltage, frequency, number of phases, and other quantities or characteristics of a power supply system. Converters usually contain safety capacitors. Safety capacitors include X capacitors for suppressing differential mode interference and Y capacitors for suppressing common mode interference. Due to leakage current limitations, the capacitance values of Y capacitors should not be too large.

In order to meet the electromagnetic compatibility requirements, grounded Y capacitors are usually installed at an input side of the converter and at direct-current (DC) busbar with screws. IT system is one of the grounding systems mentioned in the international standard IEC60364. The IT system is not directly connected to the earth, and the exposed conductive parts of electrical devices are connected to the ground through protective ground wires.

When a converter is used in an IT system, it is necessary to manually remove the screws to remove grounded Y capacitors. Therefore, it is necessary to reserve a space for removing the screws in the converter, which brings difficulties to the structural design of the converter. In addition, manual removal of the screws also brings difficulty in operation and is prone to mis operation.

### SUMMARY

Embodiments of the teachings present disclosure include converters, control methods therefor, electrical devices, and readable storage media. For example, some embodiments include a converter, comprising: a Y capacitor (11), comprising a first terminal (21) and a second terminal (22); a switch (12), comprising a third terminal (31) and a fourth terminal (32); and a control unit (13), configured to determine type information of a power supply system of the converter and control a state of the switch (12) based on the type information; wherein the first terminal (21) is connected to a DC bus of the converter or the power supply system of the converter, the third terminal (31) is connected to the second terminal (22), and the fourth terminal (32) is connected to the ground.

In some embodiments, the control unit (13) is configured to perform at least one of the following: controlling the switch (12) to be in an opened state when the type information indicates that the power supply system is an IT system; controlling the switch (12) to be in a closed state when the type information indicates that the power supply system is a TN system; controlling the switch (12) to be in a closed state when the type information indicates that the power supply system is a TT system.

In some embodiments, the Y capacitor (11) comprises: a first Y capacitor (C1), the first terminal of the first Y capacitor (C1) is connected to a first input line (L1) of the power supply system; a second Y capacitor (C2), the first terminal of the second Y capacitor (C2) is connected to a second input line (L2) of the power supply system; and a third Y capacitor (C3), the first terminal of the third Y capacitor (C3) is connected to a third input line (L3) of the power supply system; wherein the switch (12) comprising a first switch (51), the third terminal of the first switch (51) is connected to the second terminal of the first Y capacitor (C1), and the second terminal of the second Y capacitor (C2) and the second terminal of the third Y capacitor (C3), the fourth terminal of the first switch (51) is connected to the ground; wherein the control unit (13) is configured to control the first switch (51) to be in an opened state when the type information indicates that the power supply system is an IT system, and to control the first switch (51) to be in a closed state when the type information indicates that the power supply system is a TN system, and to control the first switch (51) to be in a closed state when the type information indicates that the power supply system is a TT system.

In some embodiments, the Y capacitor (11) comprises: a fourth Y capacitor (C4), the first terminal of the fourth Y capacitor (C4) is connected to a positive electrode of the DC bus; a fifth Y capacitor (C5), the first terminal of the fifth Y capacitor (C5) is connected to a negative electrode of the DC bus; wherein the switch (12) comprising a second switch (52), the third terminal of the second switch (52) is connected to the second terminal of the fourth Y capacitor (C4) and the second terminal of the fifth Y capacitor (C5), the fourth terminal of the second switch (52) is connected to the ground; wherein the control unit (13) is configured to control the second switch (52) to be in an opened state when the type information indicates that the power supply system is an IT system, and to control the second switch (52) to be in a closed state when the type information indicates that the power supply system is a TN system, and to control the second switch (52) to be in a closed state when the type information indicates that the power supply system is a TT system.

In some embodiments, the Y capacitor (11) comprises: a first Y capacitor (C1), the first terminal of the first Y capacitor (C1) is connected to a first input line (L1) of the power supply system; a second Y capacitor (C2), the first terminal of the second Y capacitor (C2) is connected to a second input line (L2) of the power supply system; a third Y capacitor (C3), the first terminal of the third Y capacitor (C3) is connected to a third input line (L3) of the power supply system; a fourth Y capacitor (C4), the first terminal of the fourth Y capacitor (C4) is connected to a positive electrode of the DC bus; and a fifth Y capacitor (C5), the first terminal of the fifth Y capacitor (C5) is connected to a negative electrode of the DC bus; wherein the switch (12) comprising a first switch (51) and a second switch (52), the third terminal of the first switch (51) is connected to the second terminal of the first Y capacitor (C1), and the second terminal of the second Y capacitor (C2) and the second terminal of the third Y capacitor (C3), the fourth terminal of the first switch (51) is connected to the ground; the third terminal of the second switch (52) is connected to the second terminal of the fourth Y capacitor (C4) and the second terminal of the fifth Y capacitor (C5), the fourth terminal of the second switch (52) is connected to the ground; wherein the control unit (13) is configured to control both the first switch (51) and the second switch (52) to be in an opened state when the type information indicates that the power supply system is an IT system, and to control both the first switch (51) and the second switch (52) to be in a closed state when the type information indicates that the power supply system is a TN system, and to control both the first switch (51) and the second switch (52) to be in a closed state when the type information indicates that the power supply system is a TT system.

As another example, some embodiments include a method for controlling a converter, wherein the converter comprises: a Y capacitor, comprising a first terminal and a second terminal; a switch, comprising a third terminal and a fourth terminal; wherein the first terminal is connected to a DC bus of the converter or a power supply system of the converter, the third terminal is connected to the second terminal, and the fourth terminal is connected to the ground; the method comprising: determining (501) type information of the power supply system of the converter; and controlling (501) a state of the switch based on the type information.

In some embodiments, controlling (501) a state of the switch based on the type information comprising at least one of the following: controlling the switch to be in an opened state when the type information indicates that the power supply system is an IT system; controlling the switch to be in a closed state when the type information indicates that the power supply system is a TN system; controlling the switch to be in a closed state when the type information indicates that the power supply system is a TT system.

In some embodiments, controlling the switch to be in an opened state comprises: detecting current state of the switch; and sending a switch-off command to the switch so that the switch switches to the opened state based on the switch-off command when the current state of the switch is closed.

In some embodiments, controlling the switch to be in a closed state comprises: detecting current state of the switch; and sending a switch-on command to the switch so that the switch switches to the closed state based on the switch-on command when the current state of the switch is opened.

In some embodiments, determining (501) type information of the power supply system of the converter comprises: providing a user interface; and receiving a configuration file based on the user interface, the configuration file containing the type information of the power supply system of the converter.

As another example, some embodiments include an electrical device, comprising a processor (601) and a memory (602), wherein an application program executable by the processor (601) is stored in the memory (602) for causing the processor (601) to execute one or more of the methods for controlling a converter described herein.

As another example, some embodiments include a computer-readable medium comprising computer-readable instructions stored thereon, wherein the computer-readable instructions for executing one or more of the methods for controlling a converter described herein.

As another example, some embodiments include a computer program product comprising a computer program, upon the computer program is executed by a processor for executing one or more of the methods for controlling a converter described herein.

### BRIEF DESCRIPTION OF THE DRAWINGS

In order to make technical solutions of examples of the present disclosure clearer, accompanying drawings to be used in description of the examples will be simply introduced hereinafter. Obviously, the accompanying drawings to be described hereinafter are only some examples of the present disclosure. Those skilled in the art may obtain other drawings according to these accompanying drawings without creative labor.

FIG. 1 is a structure diagram of an example converter incorporating teachings of the present disclosure;

FIG. 2 is a structure diagram of an example converter incorporating teachings of the present disclosure;

FIG. 3 is a structure diagram of an example converter incorporating teachings of the present disclosure;

FIG. 4 is a structure diagram of an example converter incorporating teachings of the present disclosure;

FIG. 5 is a flowchart of an example method for controlling converter incorporating teachings of the present disclosure; and

FIG. 6 is a structure diagram of an example electrical device incorporating teachings of the present disclosure.

### LIST OF REFERENCE NUMBERS

| reference numbers | meanings |
|---|---|
| 11 | Y capacitor |
| 12 | switch |
| 13 | control unit |
| 21 | first terminal |
| 22 | second terminal |
| 31 | third terminal |
| 32 | fourth terminal |
| 40 | power supply system |
| 41 | rectifier module |
| 42 | bus capacitor |
| 43 | inverter module |
| 44 | motor |
| 61/62/63 | converter |
| C1 | first Y capacitor |
| C2 | second Y capacitor |
| C3 | third Y capacitor |
| C4 | fourth Y capacitor |
| C5 | fifth Y capacitor |
| 51 | first switch |
| 52 | second switch |
| 501~502 | steps |
| 600 | electrical device |
| 601 | processor |
| 602 | memory |

### DETAILED DESCRIPTION

Some embodiments of the teachings herein include a converter comprising: a Y capacitor, comprising a first terminal and a second terminal; a switch, comprising a third terminal and a fourth terminal; and a control unit, configured to determine type information of a power supply system of the converter and control a state of the switch based on the type information; wherein the first terminal is connected to a DC bus of the converter or the power supply system of the converter, the third terminal is connected to the second terminal, and the fourth terminal is connected to the ground.

Various embodiments of the teachings of the present disclosure control the state of the switch based on type information of power supply system, realize automatic control of grounding state of Y capacitor, eliminate the need to reserve space for removing screws in the converter, and reduce the difficulty of the structural design of the converter. In addition, it also reduces the risk of mis operation when manually removing screws.

In some embodiments, the control unit is configured to perform at least one of the following: controlling the switch to be in an opened state when the type information indicates that the power supply system is an IT system; controlling the switch to be in a closed state when the type information indicates that the power supply system is a TN system; or controlling the switch to be in a closed state when the type information indicates that the power supply system is a TT system. Therefore, corresponding Y capacitor grounding strategy can be realized based on different types of power supply systems.

In some embodiments, the Y capacitor comprises: a first Y capacitor, the first terminal of the first Y capacitor is connected to a first input line of the power supply system; a second Y capacitor, the first terminal of the second Y capacitor is connected to a second input line of the power supply system; and a third Y capacitor, the first terminal of the third Y capacitor is connected to a third input line of the power supply system; wherein the switch comprising a first switch, the third terminal of the first switch is connected to the second terminal of the first Y capacitor, and the second terminal of the second Y capacitor and the second terminal of the third Y capacitor, the fourth terminal of the first switch is connected to the ground; wherein the control unit is configured to control the first switch to be in an opened state when the type information indicates that the power supply system is an IT system, and to control the first switch to be in a closed state when the type information indicates that the power supply system is a TN system, and to control the first switch to be in a closed state when the type information indicates that the power supply system is a TT system. Therefore, the grounding state of Y capacitors at the input side is automatically controlled.

In some embodiments, the Y capacitor comprises: a fourth Y capacitor, the first terminal of the fourth Y capacitor is connected to a positive electrode of the DC bus; a fifth Y capacitor, the first terminal of the fifth Y capacitor is connected to a negative electrode of the DC bus; wherein the switch comprising a second switch, the third terminal of the second switch is connected to the second terminal of the fourth Y capacitor and the second terminal of the fifth Y capacitor, the fourth terminal of the second switch (52) is connected to the ground; wherein the control unit is configured to control the second switch to be in an opened state when the type information indicates that the power supply system is an IT system, and to control the second switch to be in a closed state when the type information indicates that the power supply system is a TN system, and to control the second switch to be in a closed state when the type information indicates that the power supply system is a TT system. Therefore, the grounding state of Y capacitors at the bus capacitor is automatically controlled.

In some embodiments, the Y capacitor comprises: a first Y capacitor, the first terminal of the first Y capacitor is connected to a first input line of the power supply system; a second Y capacitor, the first terminal of the second Y capacitor is connected to a second input line of the power supply system; a third Y capacitor, the first terminal of the third Y capacitor is connected to a third input line of the power supply system; a fourth Y capacitor, the first terminal of the fourth Y capacitor is connected to a positive electrode of the DC bus; and a fifth Y capacitor, the first terminal of the fifth Y capacitor is connected to a negative electrode of the DC bus; wherein the switch comprising a first switch and a second switch, the third terminal of the first switch is connected to the second terminal of the first Y capacitor, and the second terminal of the second Y capacitor and the second terminal of the third Y capacitor, the fourth terminal of the first switch is connected to the ground; the third terminal of the second switch is connected to the second terminal of the fourth Y capacitor and the second terminal of the fifth Y capacitor, the fourth terminal of the second switch is connected to the ground; wherein the control unit is configured to control both the first switch and the second switch to be in an opened state when the type information indicates that the power supply system is an IT system, and to control both the first switch and the second switch to be in a closed state when the type information indicates that the power supply system is a TN system, and to control both the first switch and the second switch to be in a closed state when the type information indicates that the power supply system is a TT system. Therefore, the grounding state of Y capacitors at both input side and bus capacitor side is automatically controlled.

Some embodiments include a method for controlling a converter, wherein the converter comprises: a Y capacitor, comprising a first terminal and a second terminal; a switch, comprising a third terminal and a fourth terminal; wherein the first terminal is connected to a DC bus of the converter or a power supply system of the converter, the third terminal is connected to the second terminal, and the fourth terminal is connected to the ground. The method comprises: determining type information of the power supply system of the converter; and controlling a state of the switch based on the type information.

Various embodiments of the present disclosure control the state of the switch based on the type information of the power supply system, realize automatic control of grounding state of Y capacitor, eliminate the need to reserve space for removing screws in the converter, and reduce the difficulty of the structural design of the converter. In addition, it also reduces the risk of mis operation when manually removing screws.

In some embodiments, controlling a state of the switch based on the type information comprising at least one of the following: controlling the switch to be in an opened state when the type information indicates that the power supply system is an IT system; controlling the switch to be in a closed state when the type information indicates that the power supply system is a TN system; or controlling the switch to be in a closed state when the type information indicates that the power supply system is a TT system. Therefore, corresponding Y capacitor grounding strategy can be realized based on different types of power supply systems.

In some embodiments, controlling the switch to be in an opened state comprising: detecting current state of the switch; and sending a switch-off command to the switch so that the switch switches to the opened state based on the switch-off command when the current state of the switch is closed. Therefore, the switch that is currently closed can be automatically switched to open.

In some embodiments, controlling the switch to be in a closed state comprising: detecting current state of the switch; and sending a switch-on command to the switch so that the switch switches to the closed state based on the switch-on command when the current state of the switch is opened. Therefore, the switch that is currently opened can be automatically switched to close.

In some embodiments, the determining type information of the power supply system of the converter comprises: providing a user interface; and receiving a configuration file based on the user interface, the configuration file containing the type information of the power supply system of the converter. Therefore, the type information of the power supply system can be conveniently received, which improves control efficiency.

Some embodiments include an electronic device comprising a processor and a memory, wherein an application program executable by the processor is stored in the memory for causing the processor to execute one or more methods for controlling a converter as described herein.

Some embodiments include a computer-readable medium comprising computer-readable instructions stored thereon is provided, wherein the computer-readable instructions for controlling a converter as described herein.

Some embodiments include a computer program product comprising a computer program. When the computer program is executed it causes a processor to execute one or more of the methods for controlling a converter as described herein.

In order to make the purpose, technical schemes, and advantages of the teachings herein more clear, the following examples are given to further explain the teachings in detail. Many details in the embodiments are only used to help explain the teachings of the present disclosure. However, it is obvious that the technical schemes can be realized without being limited to these details. In order to avoid unnecessarily blurring, some embodiments are not described in detail, but only the framework is given. Hereinafter, “including” refers to “including but not limited to”, “according to . . . ” refers to “at least according to . . . , but not limited to . . . ”. Due to the language habits of Chinese, when the number of an element is not specifically indicated below, it means that the element can be one or more, or can be understood as at least one.

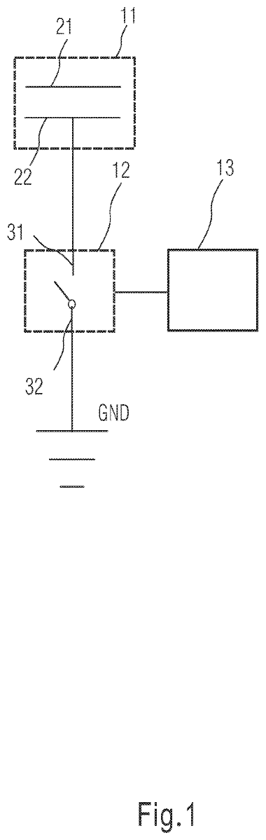

FIG. 1 is a structure diagram of an example converter incorporating teachings of the present disclosure. The converter comprises: a Y capacitor 11 comprising a first terminal 21 and a second terminal 22; a switch 12 comprising a third terminal 31 and a fourth terminal 32; and a control unit 13, configured to determine type information of a power supply system of the converter and to control the state of the switch 12 based on the type information.

The first terminal 21 of Y capacitor 11 is connected to a DC bus of the converter or the power supply system of the converter, the third terminal 31 of switch 12 is connected to the second terminal 22 of Y capacitor 11, and the fourth terminal 32 of switch 12 is grounded (GND).

The switch 12 is an electronic element that interrupts current or causes it to flow to other circuits. The switch 12 may include one or more electronic contacts. The closed switch indicates that the electronic contact is on, allowing the current to flow through the switch 12, also known as the “ON state” of the switch. Opened switch means that the electronic contact is not conductive, thus forming an open circuit and the current is not allowed to flow through the switch 12, which is also called the “OFF state” of the switch. Specifically, the switch 12 may be implemented as a solid-state switch or an electromagnetic relay, and the like.

The third terminal 31 of switch 12 is connected to the second terminal 22 of Y capacitor 11, and the fourth terminal 32 of switch 12 is grounded. Therefore, when the switch 12 is opened, the Y capacitor 11 is not connected to the ground. When switch 12 is closed, Y capacitor 11 is connected to ground.

According to the regulations of the International Electrotechnical Commission, the grounding systems of low-voltage distribution system usually include IT system, TT system and TN system. For IT, TT and TN, the letter meanings include:

(1) The first letter indicates the relationship between the power supply terminal and the ground, in which: T-indicates that one point of the power terminal is directly grounded, I-indicates that all live parts of the power terminal are ungrounded or one point is grounded through impedance

(2) The second letter indicates the relationship between the exposed conductive part of the electrical device and the ground, where: T-indicates that the exposed conductive part of the electrical device is directly grounded, and this grounding point is electrically independent from the grounding point of the power terminal; N-indicates that there is a direct electrical connection between the exposed conductive part of the electrical device and the power terminal grounding point.

The IT system is a system in which the neutral point of the power supply is not grounded and the exposed conductive part of the electrical equipment is directly grounded. TT system is a system in which the neutral point of power supply is directly grounded, and the exposed conductive parts of electrical equipment are also directly grounded. TN system is usually a three-phase power grid system with neutral point grounded. It is characterized by that the exposed conductive part of electrical equipment is directly connected with the system grounding point. In case of short circuit, the short circuit current forms a closed loop through metal wires. Specifically, TN system can include TN-C system, TN-S system, and TN-C-S system.

The control unit 12 may include a user interface. The control unit 12 receives a configuration file based on the user interface, and the configuration file contains type information of the power supply system of the converter.

In some embodiments, the control unit 13 is configured to perform at least one of the following:
(1) When the type information indicates that the power supply system is an IT system, the control switch 12 is opened;
(2) When the type information indicates that the power supply system is TN system, the control switch 12 is closed; and
(3) When the type information indicates that the power supply system is TT system, the control switch 12 is closed.

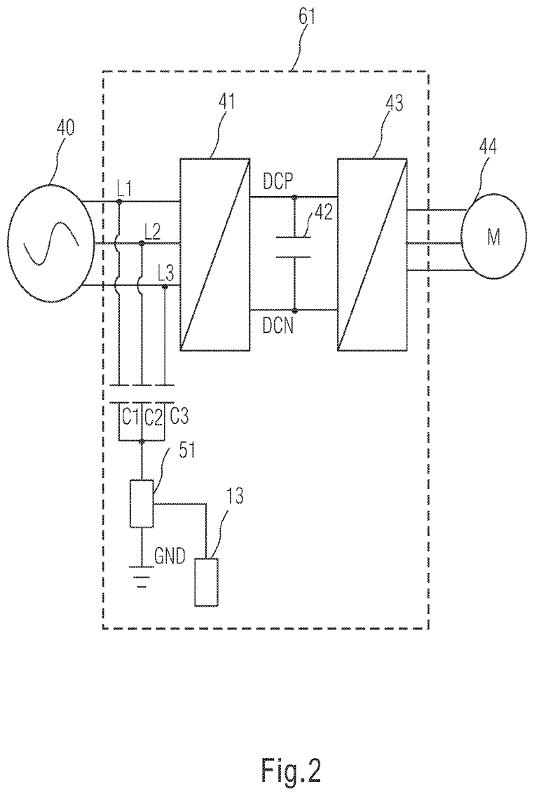

FIG. 2 is a structure diagram of an example converter incorporating teachings of the present disclosure. In FIG. 2, the converter 61 is arranged between power supply system 40 and motor 44, and the converter 61 acts as driver of the motor 44. The converter 61 includes a rectifier module 41 (such as an AC/DC converter), a bus capacitor 42, and an inverter module (such as a DC/AC converter) 43. The rectifier module 41 converts alternating current provided by the power supply system 40 into direct current (DC); The bus capacitor 42 filters the DC supplied by the rectifier module 41; The inverter module 43 converts the filtered DC into AC power for driving the motor 44.

The first terminal of the first Y capacitor C1 is connected with a first input line L1 of the power supply system 40; The first terminal of the second Y capacitor C2 is connected with a second input line L2 of the power supply system 40; The first terminal of the third Y capacitor C3 is connected with a third input line L3 of the power supply system 40. L1 line, L2 line and L3 line are three-phase (phase A, phase B and phase C respectively) live wires of power supply system 40.

One terminal of the first switch 51 (equivalent to the third terminal 31 of the switch 12 in FIG. 1) is connected to the second terminal of the first Y capacitor C1, the second terminal of the second Y capacitor C2 and the second terminal of the third Y capacitor C3; The other terminal of the first switch 51 (equivalent to the fourth terminal 32 of the switch 12 in FIG. 1) is grounded. The first switch 51 may also include a control terminal connected to the control unit 13. The first switch 51 receives a switch state command. from the control unit 13 via the control terminal. The first switch 51 switches its own state to an opened state or a closed state based on the switch state command.

The control unit 13 is configured to provide a user interface; A configuration file is received based on the user interface, and the configuration file contains type information of the power supply system 40. When the type information indicates that the power supply system 40 is an IT system, the control unit 13 controls the first switch 51 to be in opened state; When the type information indicates that the power supply system is a TN system, the control unit 13 controls the first switch 51 to be in a closed state; When the type information indicates that the power supply system is a TT system, the control unit 13 controls the first switch 51 to be in a closed state. Therefore, when the first switch 51 is in opened state, the first Y capacitor C1, the second Y capacitor C2 and the third Y capacitor C3 are not grounded; When the first switch 51 is in closed state, the first Y capacitor C1, the second Y capacitor C2 and the third Y capacitor C3 are all grounded.

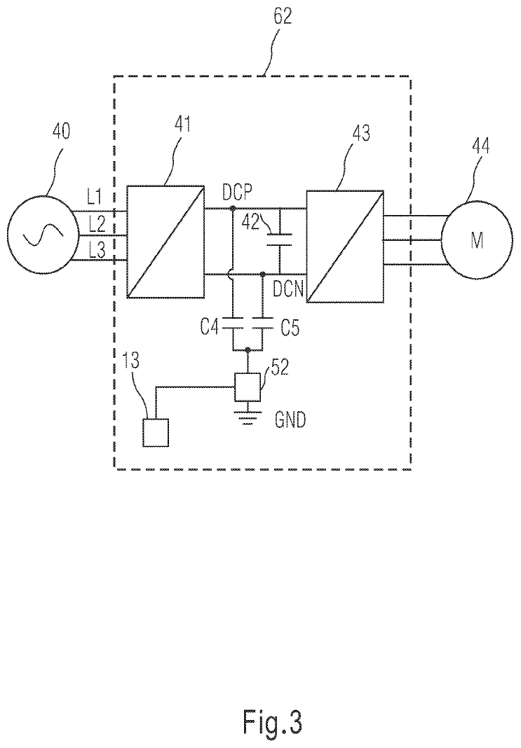

FIG. 3 is a structure diagram of an example converter incorporating teachings of the present disclosure. In FIG. 3, the converter 62 is arranged between power supply system 40 and motor 44, and the converter 62 acts as driver of the motor 44. The converter 62 includes a rectifier module 41 (such as an AC/DC converter), a bus capacitor 42, and an inverter module (such as a DC/AC converter) 43. The rectifier module 41 converts alternating current provided by the power supply system 40 into direct current; The bus capacitor 42 filters the DC supplied by the rectifier module 41; The inverter module 43 converts the filtered DC into AC power for driving the motor 44.

The first terminal of the fourth Y capacitor C4 is connected with a positive electrode (DCP) of the DC bus; The first terminal of the fifth Y capacitor C5 is connected to a negative electrode (DCN) of the DC bus. One terminal of the second switch 52 (equivalent to the third terminal 31 of the switch 12 in FIG. 1) is connected to the second terminal of the fourth Y capacitor C4 and the second terminal of the fifth Y capacitor C5. The other terminal of the second switch 52 (equivalent to the fourth terminal 32 of the switch 12 in FIG. 1) is grounded. The second switch 52 may also include a control terminal connected to the control unit 13. The second switch 52 receives a s switch state command from the control unit 13 via the control terminal. The second switch 52 switches its own state to an opened state or a closed state based on the switch state command.

The control unit 13 is configured to provide a user interface; A configuration file is received based on the user interface, and the configuration file contains type information of the power supply system 40. When the type information indicates that the power supply system 40 is an IT system, the control unit 13 controls the second switch 52 to be in opened state (that is, disconnected); When the type information indicates that the power supply system is a TN system, the control unit 13 controls the second switch 52 to be in a closed state (that is, connected); When the type information indicates that the power supply system is a TT system, the control unit 13 controls the second switch 52 to be in a closed state. Therefore, when the second switch 52 is in opened state, the fourth Y capacitor C4 and the fifth Y capacitor C5 are not grounded; When the second switch 52 is in closed state, the fourth Y capacitor C4 and the fifth Y capacitor C5 are grounded.

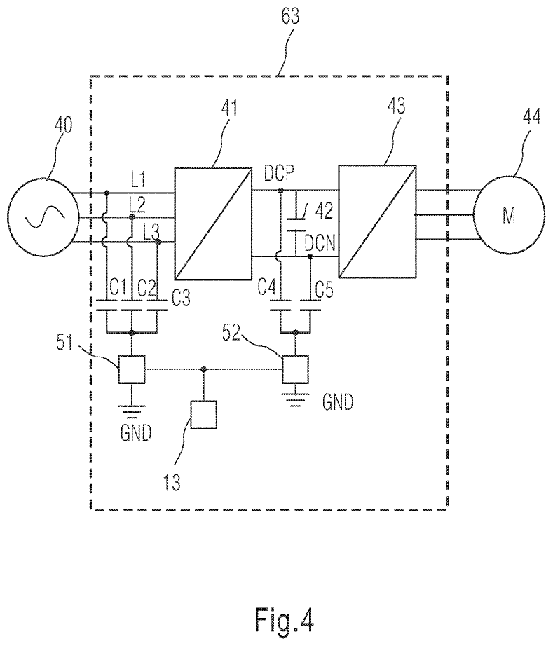

FIG. 4 is a structure diagram of an example converter incorporating teachings of the present disclosure. In FIG. 4, the converter 63 is arranged between power supply system 40 and motor 44, and the converter 63 acts as driver of the motor 44. The converter 63 includes a rectifier module 41 (such as an AC/DC converter), a bus capacitor 42, and an inverter module (such as a DC/AC converter) 43. The rectifier module 41 converts alternating current provided by the power supply system 40 into direct current; The bus capacitor 42 filters the DC supplied by the rectifier module 41; The inverter module 43 converts the filtered DC into AC power for driving the motor 44. In FIG. 4, the switch 12 in FIG. 1 is specifically implemented with the first switch 51 and the second switch 52.

The first terminal of the first Y capacitor C1 is connected with a first input line L1 of the power supply system 40; The first terminal of the second Y capacitor C2 is connected with a second input line L2 of the power supply system 40; The first terminal of the third Y capacitor C3 is connected with a third input line L3 of the power supply system 40. L1 line, L2 line and L3 line are three-phase (phase A, phase B and phase C respectively) live wires of power supply system 40.

One terminal of the first switch 51 (equivalent to the third terminal 31 of the switch 12 in FIG. 1) is connected to the second terminal of the first Y capacitor C1, the second terminal of the second Y capacitor C2, and the second terminal of the third Y capacitor C3. The other terminal of the first switch (equivalent to the fourth terminal 32 of the switch 12 in FIG. 1) is grounded. The first switch 51 may also include a control terminal connected to the control unit 13. The first switch 51 receives a switch state command from the control unit 13 via the control terminal. The first switch 51 switches its own state to an opened state or a closed state based on the switch state command.

The first terminal of the fourth Y capacitor C4 is connected with a positive electrode (DCP) of the DC bus; the first terminal of the fifth Y capacitor C5 is connected to a negative electrode (DCN) of the DC bus. One terminal of the second switch 52 (equivalent to the third terminal 31 of the switch 12 in FIG. 1) is connected to the second terminal of the fourth Y capacitor C4 and the second terminal of the fifth Y capacitor C5. The other terminal of the second switch 52 (equivalent to the fourth terminal 32 of the switch 12 in FIG. 1) is grounded. The second switch 52 may also include a control terminal connected to the control unit 13. The second switch 52 receives a switch state command from the control unit 13 via the control terminal. The second switch 52 switches its own state to an opened state or a closed state based on the switch state command.

The control unit 13 is configured to provide a user interface; A configuration file is received based on the user interface, and the configuration file contains type information of the power supply system 40. When the type information indicates that the power supply system 40 is an IT system, the control unit 13 controls both the first switch 51 and the second switch 52 to be in in opened state; When the type information indicates that the power supply system is a TN system, the control unit 13 controls both the first switch 51 and the second switch 52 to be in a closed state; When the type information indicates that the power supply system is a TT system, the control unit 13 controls both the first switch 51 and the second switch 52 to be in a closed state. Therefore, when the first switch 51 and the second switch 52 are in opened state, the first Y capacitor C1, the second Y capacitor C2, the third Y capacitor C3, the fourth Y capacitor C4 and the fifth Y capacitor C5 are not grounded; When the first switch 51 and the second switch 52 are closed, the first Y capacitor C1, the second Y capacitor C2, the third Y capacitor C3, the fourth Y capacitor C4 and the fifth Y capacitor C5 are grounded.

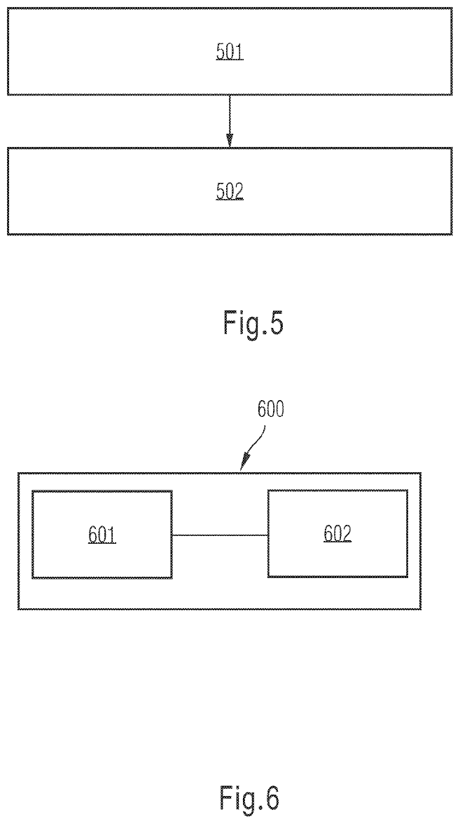

Some embodiments include converter control methods. FIG. 5 is a flowchart of an example method for controlling converter incorporating teachings of the present disclosure. The converter comprises: Y capacitor comprising first terminal and second terminal; switch comprising third terminal and fourth terminal; the first terminal is connected to DC bus of the converter or power supply system of the converter, the third terminal is connected to the second terminal, and the fourth terminal is grounded. As shown in FIG. 5, the method comprises:

Step 501: determining type information of the power supply system of the converter. Here, a user interface is provided; a configuration file is received through on the user interface. The configuration file contains type information of the power supply system of the converter. Type information includes type information indicating that the power supply system is IT system, TN system or TT system, wherein TN system comprising TN-C system, TN-S system, and TN-C-S system.

Step 502: controlling the state of the switch based on the type information. Here, when the type information indicates that the power supply system is an IT system, the switch is controlled to be in an opened state; When the type information indicates that the power supply system is TN system, the switch is controlled to be in a closed state; When the type information indicates that the power supply system is TT system, the switch is controlled to be in a closed state.

In some embodiments, controlling switch to be in an opened state comprises detecting a current state of the switch. When the current state of the switch is closed, a switch-off command is sent to the switch, so that the switch switches from closed state to opened state based on the switch-off command.

In some embodiments, controlling the switch to be in a closed state comprises: detecting current state of the switch; and sending a switch-on command to the switch so that the switch switches to the closed state based on the switch-on command when the current state of the switch is opened.

Some embodiments include an electrical device with a processor-memory architecture. FIG. 6 is a structure diagram of an example electrical device incorporating teachings of the present disclosure. As shown in FIG. 6, the electrical device 600 comprising a processor 601, a memory 602, and a computer program stored on the memory 602 and capable of running on the processor 601. When the computer program is executed by the processor 601, one or more of the converter control methods as described above is implemented.

In some embodiments, the memory 602 can be specifically implemented as EEPROM, Flash memory, PROM, and other storage media. The processor 601 may be implemented to include one or more central processors or one or more field programmable gate arrays, wherein the field programmable gate arrays integrate one or more central processor cores. Specifically, the central processor or central processor core can be implemented as a CPU or MCU or DSP, and so on.

It should be noted that not all steps and modules in the above processes and structure diagrams are necessary, and some steps or modules can be ignored according to actual needs. The execution sequence of each step is not fixed and can be adjusted as required. The division of each module is only for the convenience of describing the division functional adopted. In actual implementation, a module can be divided into multiple modules, and the functions of multiple modules can also be realized by the same module. These modules can be located in the same device or in different devices.

The hardware modules in each embodiment may be implemented mechanically or electronically. For example, a hardware module can include a specially designed permanent circuit or logic device (such as a special processor, such as FPGA or ASIC) to complete a specific operation. Hardware modules may also include programmable logic devices or circuits temporarily configured by software, such as including general-purpose processors or other programmable processors, for performing specific operations. As for the specific implementation of hardware modules by mechanical means, or by special permanent circuits, or by temporarily configured circuits (such as those configured by software), it can be determined according to the consideration of cost and time.

The above description is only an example embodiment of the teachings of the present disclosure and is not intended to limit the protection scope thereof. Any modification, equivalent replacement, improvement, etc. made within the spirit and principle of the disclosure shall be included in the protection scope thereof.

What is claimed is:

1. A converter comprising:
a Y capacitor comprising a first terminal and a second terminal;
a switch comprising a third terminal Hand a fourth terminal; and
a control unit to determine type information of a power supply system of the converter and control a state of the switch based on the type information;
wherein the first terminal is connected to a DC bus of the converter or the power supply system of the converter;
the third terminal is connected to the second terminal; and
the fourth terminal is connected to the ground.

2. The converter according to claim 1, wherein the control unit is configured to perform at least one of the following:
controlling the switch to be in an opened state when the type information indicates that the power supply system is an IT system;
controlling the switch to be in a closed state when the type information indicates that the power supply system is a TN system; and
controlling the switch to be in a closed state when the type information indicates that the power supply system is a TT system.

3. The converter according to claim 1, wherein the Y capacitor comprises:
a first Y capacitor with a first terminal connected to a first input line of the power supply system;
a second Y capacitor with a first terminal connected to a second input line of the power supply system; and
a third Y capacitor with a first terminal connected to a third input line of the power supply system;
wherein the switch includes a first switch with a third terminal connected to the second terminal of the first Y capacitor and a second terminal of the second Y capacitor and a second terminal of the third Y capacitor, and a fourth terminal connected to the ground;
wherein the control unit is configured to control the first switch to be in an opened state when the type information indicates that the power supply system is an IT system, and to control the first switch to be in a closed state when the type information indicates that the power supply system is a TN system, and to control the first switch to be in a closed state when the type information indicates that the power supply system is a TT system.

4. The converter according to claim 1, wherein the Y capacitor comprises:
a fourth Y capacitor with a first terminal connected to a positive electrode of the DC bus;
a fifth Y capacitor with a first terminal connected to a negative electrode of the DC bus;
wherein the switch comprises a second switch with a third terminal connected to a second terminal of the fourth Y capacitor and a second terminal of the fifth Y capacitor, and a fourth terminal of the second switch is connected to ground;
wherein the control unit is configured to control the second switch to be in an opened state when the type information indicates that the power supply system is an IT system, and to control the second switch to be in a closed state when the type information indicates that the power supply system is a TN system, and to control the second switch to be in a closed state when the type information indicates that the power supply system is a TT system.

5. The converter according to claim 1, wherein the Y capacitor comprises:
a first Y capacitor with a first terminal connected to a first input line of the power supply system;
a second Y capacitor with a first terminal connected to a second input line of the power supply system;
a third Y capacitor with a first terminal connected to a third input line of the power supply system;
a fourth Y capacitor with a first terminal connected to a positive electrode of the DC bus; and
a fifth Y capacitor with a first terminal connected to a negative electrode of the DC bus;
wherein the switch comprises a first switch and a second switch, a third terminal of the first switch connected to the second terminal of the first Y capacitor, and a second terminal of the second Y capacitor and a second terminal of the third Y capacitor, a fourth terminal of the first switch connected to the ground; the third terminal of the second switch connected to the second terminal of the fourth Y capacitor and the second terminal of the fifth Y capacitor, a fourth terminal of the second switch connected to the ground;
wherein the control unit is configured to control both the first switch and the second switch to be in an opened state when the type information indicates that the power supply system is an IT system, and to control both the first switch and the second switch to be in a closed state when the type information indicates that the power supply system is a TN system, and to control both the first switch and the second switch to be in a closed state when the type information indicates that the power supply system is a TT system.

6. A method for controlling a converter, wherein the converter comprises: a Y capacitor with a first terminal and a second terminal; a switch with a third terminal and a fourth terminal; wherein the first terminal is connected to a DC bus of the converter or a power supply system of the converter, the third terminal is connected to the second terminal, and the fourth terminal is connected to ground; the method comprising:
determining type information of the power supply system of the converter; and
controlling a state of the switch based on the type information.

7. The method according to claim 6, wherein controlling a state of the switch based on the type information comprise at least one of the following:
controlling the switch to be in an opened state when the type information indicates that the power supply system is an IT system;
controlling the switch to be in a closed state when the type information indicates that the power supply system is a TN system; and
controlling the switch to be in a closed state when the type information indicates that the power supply system is a TT system.

8. The method according to claim 7, wherein controlling the switch to be in an opened state comprises:
detecting current state of the switch; and
sending a switch-off command to the switch so that the switch switches to the opened state based on the switch-off command when the current state of the switch is closed.

9. The method according to claim 7, wherein the controlling the switch to be in a closed state comprises:
detecting current state of the switch; and
sending a switch-on command to the switch so that the switch switches to the closed state based on the switch-on command when the current state of the switch is opened.

10. The method according to claim 6, wherein determining type information of the power supply system of the converter comprises:
providing a user interface; and
receiving a configuration file based on the user interface, the configuration file containing the type information of the power supply system of the converter.

11-13. (canceled)
